(19) United States
(12) Patent Application Publication
(10) Pub. No.: US 2023/0312893 A1
(43) Pub. Date: Oct. 5, 2023

(54) PLANT AND METHOD FOR THE PRODUCTION OF AN IN-LINE BLENDED POLYMER

(71) Applicant: Borealis AG, Vienna (AT)

(72) Inventors: Mohammad Al-haj Ali, Porvoo (FI); Noureddine Ajellal, Porvoo (FI)

(21) Appl. No.: 18/022,851

(22) PCT Filed: Sep. 27, 2021
(86) PCT No.: PCT/EP2021/076502

§ 371 Date: Feb. 23, 2023

(30) Foreign Application Priority Data
Sep. 30, 2020 (EP) 20199149.4

(51) Int. Cl. C08L 23/08; B01J 19/06; B01J 19/24; C08F 210/02

(52) U.S. Cl. CPC C08L 23/0815; B01J 19/06; B01J 19/2445; C08F 210/02; C08L 2314/06; C08L 2205/025

(57) ABSTRACT

The present inventions concerns a plant producing an in-line blended polymer comprising a first polymerisation reactor and a second polymerisation reactor, the first and second polymerisation reactors having different internal volumes, and a method for producing an in-line blended polymer.

The present invention relates to a plant for the production of an in-line blended polymer and a method for the production of an in-line blended polymer. In particular, the invention relates to a plant and an in-line blending process for two reactors operating in parallel configuration.

In traditional polymer production, reactors are operated in series. Such operation allows the use of different process conditions, whereby the properties of the polymers produced in the individual reactor can be modified. Within certain limits, it is possible to modify for example the molecular weight distribution of the total material, i.e. the material produced in all reactors.

Two or more reactors can also be operated in parallel. WO 2017/108951 discloses an in-line blending process for polymers. Two or more reactor-low pressure separator units operate in parallel configuration.

US 2011/0172375 A1 discloses a plant for the continuous solution polymerization of one or more monomers. The plant comprises a primary reactor and a secondary reactor arranged to operate in parallel, in which the ratio of volume of the primary reactor to the secondary reactor is in the range of 60:40 to 95:5.

A monomer/solvent separation and recycle process is disclosed in US 2009/0259005. One or more series or parallel homogeneous polymerization reactors and a downstream gravimetric separator fluidly connected to the one or more reactors is provided.

WO2009/082468 discloses a polypropylene ethylene-propylene copolymer blends in an in-line process. This in-line process comprises two or more reactor trains in parallel and a high-pressure separator.

However, using two reactors with the same volume makes the plant non-economical if mixing two different fractions of polymers, especially in case the blend ratio is high, such as 90:10. The reason is that the production rate in one reactor has to be significantly reduced in such a case.

Furthermore, some state of the art grades of polymers have some good properties but do have the disadvantage of exhibiting slow ejection, before or during extrusion, which causes a long cooling time. This behaviour has a negative impact on process economics for several applications. It would thus be advantageous to have improved polymers targeting at the same or a similar grade, however, with faster ejection and thus shorter cooling times. In other words, there is a need in the art for improving the ejection and the cooling time of such targeted polymers.

In view of the above, there is a need in the art to provide a plant and a method for producing polymers whereby the properties of the polymer produced can be tailored or modified.

It is thus an object of the invention to provide a plant and a method for producing polymers having improved properties compared to target polymers.

It is a further object of the invention to provide a plant and a method for producing a polymer having improved ejection and shorter cooling times compared to target polymers.

It is a particular object of the invention to provide a plant and a method for producing a polymer having improved ejection and shorter cooling times compared to target polymers, but maintaining at the same time the density and the MFR₂ of these target polymers.

In the present invention it has been surprisingly found that a plant and a method for blending of two different polymers leads to polymer with significantly higher melting temperature Tₘ and improved glass transition temperature T_{g} and at the same maintaining the density and the melt flow rate of the target polymer. The significantly higher melting temperature Tₘ and improved glass transition temperature T_{g} advantageously leads to fast ejection and to shorter cooling times.

Therefore, the present invention provides in a first aspect a plant for the production of an inline-blended polymer, the plant comprising
a first reactor line for producing a first polymer,
a second reactor line for producing a second polymer, and
a blending unit for inline-blending the first polymer with the second polymer to obtain the inline-blended polymer,
the first reactor line comprising a first polymerisation reactor for producing the first polymer and a first separator, the first separator being located downstream of the first polymerisation reactor,
the second reactor line comprising a second polymerisation reactor for producing the second polymer and a second separator, the second separator being located downstream of the second polymerisation reactor,
wherein both the first separator and the second separator are connected to the blending unit, the blending unit being located downstream of both the first separator and the second separator,
wherein the first polymerisation reactor has a first internal volume and the second polymerisation reactor has a second internal volume,
characterized in that the ratio of the first internal volume to the second internal volume is in the range from 95:5 to 55:45.

The invention provides in a second aspect a plant for the production of an in-line blended polymer, the plant comprising
a first polymerisation reactor for producing a first polymer,
a second polymerisation reactor for producing a second polymer and
a blending unit for in-line blending the first polymer with the second polymer to obtain to obtain the inline-blended copolymer,
wherein both the first polymerisation reactor and the second polymerisation reactor are connected to the blending unit, the blending unit being located downstream of both the first polymerisation reactor and the second polymerisation reactor,
wherein a first heater is located downstream of the first polymerisation reactor and upstream of the blending unit and/or wherein a second heater is located downstream of the second polymerisation reactor and upstream of the blending unit,
wherein the first polymerisation reactor has a first internal volume and the second polymerisation reactor has a second internal volume,
characterized in that the ratio of the first internal volume to the second internal volume is in the range from 95:5 to 55:45.

The present invention has several surprising advantages. First, using the configuration of the plant and the different internal volumes of the two polymerisation reactors makes the process more versatile in terms of producing different grades of polymers in each reactor and blending them on molecular level which is not possible with conventional mixing methods. Hence, the plant and the process according to the invention can be used to produce different polymer grades in each reactor and obtaining an in-line blended polymer with improved properties compared to a target polymer which is produced in a single reactor.

In general, the process according to the invention allows for tailoring the molecular weight and/or the comonomer distribution in the different polymers produced in parallel reactors having different internal volume. Such tailoring is advantageous for providing specific polymers suitable for specific applications. Specific applications require properties such as, for example, seal strength and hot tack, higher thermal resistance of seal in shrinking operation of shrink film, higher thermal resistance of soft compound applications like dashboard skin.

Second, the plant and process according to the invention can also be used to produce the same grade of polymer in both parallel polymerisation reactors having different internal volume in case a higher throughput is sought for or needed. This is of particular importance when utilizing rectors with complex internals that are generally difficult to up-scale.

Apart thereof, the plant and the method according to the invention allows the blending ratio between the two polymers to be varied to a large extent, for example up to a blending ratio of 95:5 wt. %, so as to allow fine tuning of the in-line polymer to be produced.

Finally, the plant and method according to the invention allow to produce polymers maintaining the density and the MFR₂ of their target polymers. In particular, they can maintain the weight average molecular weight Mw as well as the comonomer content of their target ethylene alpha-olefin copolymers. Furthermore, while meeting the requirements of density, MFR₂, comonomer content and M_{w}, the polymers produced by the plant and method according to the invention have improved melting temperature Tₘ and improved glass transition temperature T_{g}. The latter properties allow for faster ejection and to shorter cooling times, which in turn improves the process economics for several applications.

Generally, an in-line blending process for polymers as described herein involves continuous mixing of two, or even more, intermediate polymers, optionally having different nature, to obtain a final in-line blended polymer. In-line blending processes stand opposite to traditional batch-blending processes. In batch-blending processes, the final polymer is created by combining different intermediate polymers from storage tanks in a blender.

Both the first and the second polymerization reactor according to this invention can be any reactor suitable for polymerization which can be operated in continuous mode. Such reactors are well known in the art. Suitable examples are, amongst others, autoclave or stirred tank reactors operating in continuous mode or tubular reactors. The first and/or the second polymerization reactor are preferably selected from a tubular reactor, a stirred autoclave, a tank reactor, a loop reactor. The first polymerisation reactor may be the same or different from the second polymerization reactor.

Furthermore, both the first and the second polymerization reactor according to the invention have an internal volume. With “internal volume” the volume or space inside the respective reactor is meant. Within this internal volume or space the polymerization reaction can take place.

A connecting line as disclosed herein is usually a pipe. The pipe can be optionally equipped with means for controlling e.g. the flowrate through the pipe and/or the heating.

A recycling line as disclosed herein connecting a separator and its corresponding polymerisation reactor allows the feed of separated monomer(s) back into the polymerisation reactor. The recycling line preferably connects only the separator with its corresponding reactor. In other words, a recycling line between the separator with another parallel reactor is excluded.

The terms polymer-lean vapour phase and polymer-enriched liquid phase as used herein indicate that the polymer-lean phase is a vapour phase and the polymer-enriched phase is a liquid phase.

### Detailed Description of the Plant According to the First Aspect of the Invention

The plant according to the first aspect of the invention comprises a first reactor line for producing a first polymer, the first reactor line includes a first polymerisation reactor for producing a first polymer and a first separator being located downstream of the first polymerisation reactor. Preferably, the first polymerisation reactor comprises a first reactor inlet for introducing a first feed stream into the reactor and a first reactor outlet for withdrawing a first reactor effluent stream comprising the first polymer. The first reactor outlet is preferably fluidly connected via a connecting line to an inlet of the first separator.

Preferably the first separator comprises a top outlet for withdrawing a first polymer-lean vapour stream and a bottom outlet for withdrawing a first polymer-enriched liquid stream.

Preferably, the bottom outlet of the first separator is connected via a connecting line to the blending unit.

Preferably, a connecting line connects the top outlet of the first separator either to further processing units downstream of the first separator or to the first polymerisation reactor, more preferably a connecting line connects the top outlet of the first separator to the first polymerisation reactor. In the latter case the connecting line can also be termed first recycle line as the first polymer-lean vapour stream of the first separator is recycled back to the first polymerisation reactor. Thereby, a first polymer-lean vapour stream can be recycled back from the first separator into the first polymerization reactor.

In analogy to the first reactor line, the second reactor line according to the first aspect of the invention produces a second polymer and includes a second polymerisation reactor for producing a second polymer and a second separator downstream of the second polymerisation reactor. Preferably, the second polymerisation reactor comprises a second reactor inlet for introducing a second feed stream into the reactor and a second reactor outlet for withdrawing a second reactor effluent stream comprising the second polymer. The second reactor outlet is preferably fluidly connected via a connecting line to an inlet of the second separator.

Preferably the second separator comprises a top outlet for withdrawing a second polymer-lean vapour stream and/or a bottom outlet for withdrawing a second polymer-enriched liquid stream.

Preferably, the bottom outlet of the second separator is connected via a connecting line to the blending unit.

Preferably, a connecting line connects the top outlet of the second separator either to further processing units downstream of the second separator or to the second polymerisation reactor, more preferably a connecting line connects the top outlet of the second separator to the second polymerisation reactor. In the latter case the connecting line can also be termed second recycle line as the second polymer-lean vapour stream of the second separator is recycled back to the second polymerisation reactor. Thereby, a second polymer-lean vapour stream can be recycled back from the second separator into the second polymerisation reactor.

In the first aspect of the invention, preferably a first heater is located downstream of the first polymerisation reactor and upstream of the first separator and/or a second heater is located downstream of the second polymerisation reactor and upstream of the second separator, more preferably a first heater is located downstream of the first polymerisation reactor and upstream of the first separator and a second heater is located downstream of the second polymerisation reactor and upstream of the second separator.

If present, the first heater heats the first reactor effluent stream to provide a heated first reactor effluent stream. An inlet of the first heater is fluidly connected via connecting line with the outlet of the first polymerisation reactor. An outlet of the first heater is fluidly connected via a connecting line with the inlet of the first separator.

If present, the second heater heats the second reactor effluent stream to provide a heated second reactor effluent stream. An inlet of the second heater is fluidly connected via a connecting line with the outlet of the second polymerisation reactor. An outlet of the second heater is fluidly connected via a connecting line with the inlet of the second separator.

In one embodiment, the blending unit is connected via a connecting line to the first separator, the connecting line passing the first polymer-enriched liquid stream from the first separator into the blending unit, and via a connecting line to the second separator, the connecting line passing the second polymer-enriched liquid stream from the second separator into the blending unit.

In another embodiment, a connecting line passing the first polymer-enriched liquid stream from the first separator is combined with a connecting line passing the second polymer-enriched liquid stream from the second separator at a combining junction to form a combined polymer-enriched liquid stream. The combined polymer-enriched liquid stream comprises the first polymer and the second polymer. The combining junction is located upstream of the blending unit. The blending unit is connected via a combining line to the combining junction, the combining line passing the combined polymer-enriched liquid stream to the blending unit.

In the blending unit the first polymer of the first polymer-enriched liquid stream and the second polymer of the second polymer-enriched liquid stream or the first and second polymer of the combined polymer-enriched liquid stream are in-line blended so as to obtain the in-line blended polymer.

Preferably, the blending unit further comprises an outlet for withdrawing an in-line blended polymer stream comprising the in-line blended polymer. Preferably, the outlet is a bottom outlet.

### Detailed Description of the Plant According to the Second Aspect of the Invention

The plant according to the second aspect of the invention comprises a first polymerisation reactor for producing a first polymer and a second polymerisation reactor for producing a second polymer. A first heater is located downstream of the first polymerisation reactor and upstream of a blending unit and a second heater is located downstream of second polymerisation reactor and upstream of the blending unit.

Preferably, the first polymerisation reactor comprises a first reactor inlet for introducing a first feed stream into the reactor and a first reactor outlet for withdrawing a first reactor effluent stream comprising the first polymer. Preferably, the first reactor outlet is fluidly connected via a connecting line to an inlet of a first heater.

The first heater heats the first reactor effluent stream to obtain a heated first reactor effluent stream. The first heater preferably comprises an outlet for withdrawing the heated first reactor effluent stream.

Preferably, the second polymerisation reactor comprises a second reactor inlet for introducing a second feed stream into the reactor and a second reactor outlet for withdrawing a second reactor effluent stream comprising the second polymer.

Preferably, the second reactor outlet is fluidly connected via a connecting line to an inlet of a second heater.

The second heater heats the second reactor effluent stream to obtain a heated second reactor effluent stream. The second heater preferably comprises an outlet for withdrawing the heated second reactor effluent stream.

In one embodiment, the outlet of the first heater is connected via a connecting line to an inlet of the blending unit and the outlet of the second heater is connected via a connecting line to an inlet of the blending unit.

In another embodiment, the outlet of the first heater is connected via a connecting line to a combining junction and the outlet of the second heater is connected via a connecting line to the combining junction. At the combining junction a heated combined reactor effluent stream is formed from the heated first reactor effluent stream and the heated second reactor effluent stream. The heated combined reactor effluent stream comprises both the first polymer and the second polymer. The combining junction is located upstream of the blending unit. The blending unit is connected via a combining line to the combining junction, the combining line passing the heated combined reactor effluent stream to the blending unit.

In the blending unit the first polymer of the heated first reactor effluent stream and the second polymer of the heated second reactor effluent stream or the first polymer and the second polymer of the heated combined reactor effluent stream are in-line blended so as to obtain the in-line blended polymer.

Preferably, the blending unit further comprises an outlet for withdrawing an in-line blended polymer stream comprising the in-line blended polymer. Preferably, the outlet is a bottom outlet.

In the following, preferred embodiments of the plant according to both the first and second aspect of the invention, if applicable, are disclosed.

Preferably, the first heater and/or the second heater is a heat exchanger, more preferably the first heater and the second heater is a heat exchanger

Preferably, the first separator and/or the second separator are low pressure separators, more preferably the first separator and the second separator are low pressure separators. A low pressure separator denotes a unit for separating volatile components from a relatively dilute polymer solution. The volatile components are typically present in an amount of from about 10 to about 90% by weight of the solution. In the low pressure separator a liquid phase, comprising the polymer dissolved therein, and a vapour phase coexist. Preferably, the low pressure separator is operated at a pressure of up to 20 bar, such as from 1 to 15 bar (absolute pressure), and preferably from 2 to 12 bar (absolute pressure). Low pressure separators are well known for several decades. The formation of two phases results in a polymer-enriched liquid phase and a polymer-lean vapour phase. The polymer lean vapour phase which contains unreacted monomer, solvent and traces polymer as well as heavy comonomer if present has a density of 100 kg/m³ or less.

A low pressure separator stands opposite to separation at the lower critical solution temperature (LCST), where both the polymer-enriched phase and polymer-lean phase are either substantially liquids or supercritical fluids.

Preferably, the ratio of the first internal volume to the second internal volume is from 85:15 to 60:40, more preferably 80:20 to 65:35, and most preferably 75:25 to 70:30.

Preferably, the blending unit comprises a mixer or a separator, more preferably comprises one or more mixers, such as two, three or four mixers, or one or more separators, such as two, three or four separators. Preferably, the separator is a flash separator or a low-pressure separator. The mixer is preferably a static mixer.

### Detailed Description of the Method According to the Invention

In a third aspect of the invention a method for producing an in-line blended polymer is provided. The method is preferably conducted in a plant according to the invention as described in all embodiments herein. However, the method according to the invention may also be carried out in any other suitable plant.

All preferred embodiments of the plant according to the first aspect and according to the second aspect of the invention are also preferred embodiments of the method for producing an in-line blended polymer.

The invention thus provides a method for producing an in-line blended polymer, the method being preferably performed in a plant according to the first or second aspect as described herein, the method comprising the steps of
a1) introducing a first feed stream comprising a first monomer into a first polymerisation reactor,
a2) polymerising the first monomer in the presence of a first catalyst in the first polymerisation reactor to obtain a first polymer,
a3) withdrawing a first reactor effluent stream comprising the first polymer from the first polymerisation reactor,
b1) introducing a second feed stream comprising a second monomer into a second polymerisation reactor,
b2) polymerising the second monomer in the presence of a second catalyst in the second polymerisation reactor to obtain a second polymer,
b3) withdrawing a second reactor effluent stream comprising the second polymer from the second polymerisation reactor,
c1) blending the first polymer and the second polymer in a blending unit to obtain the in-line blended polymer.

In the method according to the invention a first monomer and a second monomer, a first catalyst and a second catalyst, optionally one or more comonomers, optionally one or more chain transfer agents, and optionally one or more solvents are used for initiating a liquid polymerization. The first polymer and/or the second polymer are each produced in a high temperature solution polymerization process, preferably at temperatures higher than 100° C., as described in more detail below.

It is self explaining that the reaction conditions applied within the different reactor need not be the same, but may be different when compared with each other. This allows the production of different polymers which are finally in-line blended together. As the reaction conditions can be adjusted completely independent for the further reactor(s), the options for varying the microstructure of the polymers to be blended are very broad. For example the catalyst, the pressures, the temperatures, the monomer feed, the comonomer/monomer ratio, feed of a chain transfer agent and the like can be different.

Preferably, the first monomer and/or the second monomer is/are an alpha-olefin monomer. The first monomer and/or the second monomer has two or more carbon atoms, preferably from 2 to 10 carbon atoms. Suitable alpha-olefin monomers are selected from the group consisting of ethylene, propylene, 1-butene, 1-hexene, 1-octene, 1-decene, and styrene. More preferably the first monomer and/or the second monomer is selected from the group consisting of ethylene, propylene and 1-butene. More preferably, the first monomer and/or the second monomer is ethylene, and most preferably the first monomer and the second monomer is ethylene.

Preferably, the first feed stream further comprises a comonomer, the comonomer preferably being octene and/or the second feed stream further comprises a comonomer, the comonomer preferably being octene. More preferably, the first feed stream further comprises a comonomer, the comonomer preferably being octene and the second feed stream further comprises a comonomer, the comonomer preferably being octene

Preferably, a co-catalyst and/or an activator and/or a catalyst support and/or an external donor are introduced into the first polymerisation reactor and/or the second polymerisation reactor.

Preferably, the first catalyst comprises a metallocene complex and/or the second catalyst comprises a metallocene complex. More preferably, the first catalyst and/or the second catalyst comprises, or consists of,
(i) at least one metallocene complex,
(ii) an alum inoxane cocatalyst and/or an boron containing cocatalyst, and
(iii) optionally an aluminium alkyl compound Al(R⁷)₃, with R⁷ being a linear or branched C2-C8-alkyl group.

Preferably, the at least one metallocene complex (i) comprises, or consists of, a metallocene complex of formula (I)

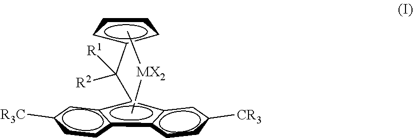

wherein M is Hf,
X is a sigma ligand,
R are the same or different from each other and can be saturated linear or branched C₁-C₁₀ alkyl, C₆-C₁₀ aryl, C₄-C₁₀ heteroaryl, C₆-C₂₀ alkylaryl or C₆-C₂₀ arylalkyl groups, which can optionally contain up to 2 heteroatoms or silicon atoms,
R¹ is a C₆-C₁₀ aryl or C₆-C₂₀ alkylaryl group optionally containing up to 2 heteroatoms or silicon atoms or a C₄-C₁₀ heteroaryl group,
R² is a C₄-C₂₀ cycloalkyl group, optionally carrying alkyl substituents in beta-positions, of formula (II)

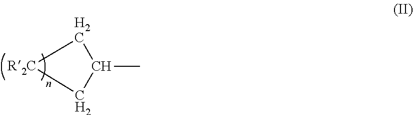

in which R′ can be the same or can be different from each other and can be hydrogen or is defined as R and n is 1 to 17,
and/or
the metallocene complex (i) comprises, or consists of, a metallocene complex of formula (III)

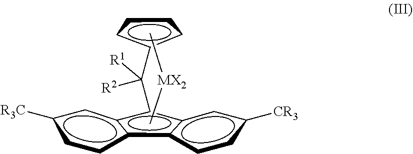

wherein M is Hf,
X is a sigma ligand,
R are the same or different from each other and can be saturated linear or branched C₁-C₁₀ alkyl, C₅-C₁₀ aryl, C₆-C₂₀ alkylaryl or C₆-C₂₀ arylalkyl groups, which can optionally contain up to 2 heteroatoms or silicon atoms,
R¹ is a C₆-C₂₀-aryl, which can be unsubstituted or substituted by one or up to 5 linear or branched C₁-C₁₀ alkyl group(s),
R² is an unsaturated linear or cyclic C₃-C₂₀ alkyl group or a branched CR³R⁴R⁵ group, wherein R³ is hydrogen or a C₁-C₂₀ alkyl group and R⁴ and
R⁵ are the same or are different and can be an C₁-C₂₀ alkyl group.

Preferably, the at least one metallocene complex of formula (I) is a metallocene complex of formula (Ia)

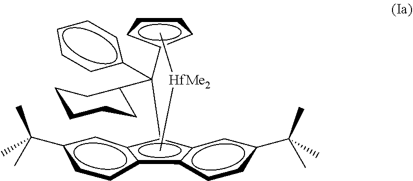

Preferably, the at least one metallocene complex of formula (III) is a metallocene complex of formula (IIIa)

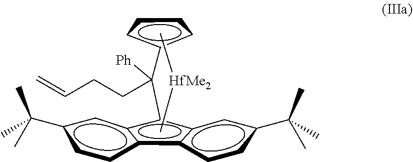

((Phenyl)(3-buten-1-yl)methylene(cyclopentadienyl) (2,7-di-tert-butylfluoren-9-yl) hafnium dimethyl),

Most preferably (Phenyl)(cyclohexyl)methylene(cyclopentadienyl)(2,7-di-tert-butylfluoren-9-yl)hafnium dimethyl) is used as metallocene complex (i).

The above mentioned metallocene complexes of formulae (I) and (III) and their preparation are described in more detail in WO2018108917 and WO2018108918.

As cocatalyst (ii) either an alum inoxane or a boron containing cocatalyst or mixtures therefrom can be used.

The aluminoxane cocatalyst can be one of formula (IV)

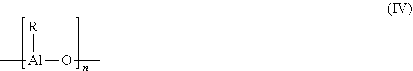

where n is from 6 to 20 and R has the meaning below.

Aluminoxanes are formed on partial hydrolysis of organoaluminum compounds, for example those of the formula AlR₃, AlR₂Y and Al₂R₃Y₃ where R can be, for example, C₁-C₁₀-alkyl, preferably C₁-C₅-alkyl, or C₃-C₁₀-cycloalkyl, C₇-C₁₂-arylalkyl or -alkylaryl and/or phenyl or naphthyl, and where Y can be hydrogen, halogen, preferably chlorine or bromine, or C₁-C₁₀-alkoxy, preferably methoxy or ethoxy. The resulting oxygen-containing aluminoxanes are not in general pure compounds but mixtures of oligomers of the formula (IV).

The preferred aluminoxane is methylaluminoxane (MAO).

Since the aluminoxanes used according to the invention as cocatalysts are not, owing to their mode of preparation, pure compounds, the molarity of aluminoxane solutions hereinafter is based on their aluminium content.

Since the aluminoxanes used according to the invention as cocatalysts are not, owing to their mode of preparation, pure compounds, the molarity of aluminoxane solutions hereinafter is based on their aluminium content.

The molar ratio of Al in the aluminoxane to the transition metal of the metallocene may be in the range of 1:1 to 2000:1 mol/mol, preferably 10:1 to 1000:1, more preferably 50:1 to 500:1 mol/mol.

Suitable amounts of cocatalyst will be well known to the skilled man.

In an embodiment of the present invention aluminoxane (ii), preferably methylaluminoxane, and an aluminium alkyl compound of the formula Al(R⁷)₃ with R⁷ being a linear or branched C₂-C₈-alkyl group (iii) are used as cocatalyst.

In this case the cocatalyst is preferably a reaction product of (ii) the aluminoxane, preferably methylaluminoxane with (iii) the aluminium alkyl compound, such as tri-iso-butyl aluminum, tri-iso-hexyl aluminium, tri-n-octyl aluminum, tri-iso-octyl aluminium and the like. The ratio between methylalumoxane and the aluminium alkyl compound can be between 10:1 and 1:10, preferably 5:1 to 1:5, most preferably 3:1 to 1:3 moles of Al in the methylalumoxane to moles of aluminium of the aluminium alkyl compound. The reaction between methylaluminoxane and the aluminium alkyl compound is carried out by mixing the two components in a suitable solvent, which can be aromatic or aliphatic, at a temperature between −50° to +80° C., preferably between 10° and 50° C., more preferably between 20° and 40° C.

Boron based cocatalysts of interest include boron compounds containing a borate 3+ ion, i.e. borate compounds. These compounds generally contain an anion of formula:

(Z)₄B⁻ (V)
where Z is an optionally substituted phenyl derivative, said substituent being a haloC1-6-alkyl or halo group. Preferred options are fluoro or trifluoromethyl. Most preferably, the phenyl group is perfluorinated.

Such ionic cocatalysts preferably contain a non-coordinating anion such as tetrakis(pentafluorophenyl)borate.

Suitable counterions are protonated amine or aniline derivatives or phosphonium ions. These may have the general formula (VI) or (VII):

NQ₄⁺ (VI)

or PQ₄⁺ (VII)

where Q is independently H, C1-6-alkyl, C3-8 cycloalkyl, phenylC1-6-alkylene- or optionally substituted Ph. Optional substituents may be C1-6-alkyl, halo or nitro. There may be one or more than one such substituent. Preferred substituted Ph groups include therefore para-substituted phenyl, preferably tolyl or dimethylphenyl.

It is preferred if at least one Q group is H, thus preferred compounds are those of formula:

NHQ₃₊ (VIII)

or PHQ₃⁺ (IX)

Preferred phenylC1-6-alkyl- groups include benzyl.

Suitable counterions therefore include: methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, p-bromo-N,N-dimethylanilinium or p-nitro-N,N-dimethylanilinium, especially dimethylammonium or N,N-dimethylanilinium. The use of pyridinium as an ion is a further option.

Phosphonium ions of interest include triphenylphosphonium, triethylphosphonium, diphenylphosphonium, tri(methylphenyl)phosphonium and tri(dimethylphenyl)phosphonium.

A more preferred counterion is trityl (CPh₃⁺) or analogues thereof in which the Ph group is functionalised to carry one or more alkyl groups. Highly preferred borates of use in the invention therefore comprise the tetrakis(pentafluorophenyl)borate ion.

Preferred ionic compounds which can be used according to the present invention include:
tributylammoniumtetra(pentafluorophenyl)borate,
tributylammoniumtetra(trifluoromethylphenyl)borate,
tributylam moniumtetra-(4-fluorophenyl)borate,
N,N-dimethylcyclohexylam moniumtetrakis-(pentafluorophenyl)borate,
N,N-dimethylbenzylammoniumtetrakis(pentafluorophenyl)borate,
N,N-dimethylaniliniumtetrakis(pentafluorophenyl)borate,
N,N-di(propyl)ammoniumtetrakis(pentafluorophenyl)borate,
di(cyclohexyl)ammoniumtetrakis(pentafluorophenyl)borate,
triphenylcarbeniumtetrakis(pentafluorophenyl)borate,
ferroceniumtetrakis(pentafluorophenyl)borate.

Preference is given to triphenylcarbeniumtetrakis(pentafluorophenyl) borate,
N,N-dimethylcyclohexylammoniumtetrakis(pentafluorophenyl)borate,
N,N-dimethylbenzylammoniumtetrakis(pentafluorophenyl)borate
or N,N-dimethylaniliniumtetrakis(pentafluorophenyl)borate.

More preferred borates are triphenylcarbeniumtetrakis(pentafluorophenyl) borate and N,N-dimethylaniliniumtetrakis(pentafluorophenyl)borate.

N,N-dimethylaniliniumtetrakis(pentafluorophenyl)borate is most preferred.

It is further possible to add an aluminium alkyl compound. Suitable aluminium alkyl compounds are compounds of the formula (VIII) AIRS with R being a linear or branched C2-C8-alkyl group.

Preferred aluminium alkyl compounds are triethylaluminium, tri-isobutylaluminium, tri-isohexylaluminium, tri-n-octylaluminium and tri-isooctylaluminium.

Suitable amounts of cocatalyst will be well known to the skilled man.

The molar ratio of boron to the metal ion of the metallocene may be in the range 0.5:1 to 10:1 mol/mol, preferably 1:1 to 10:1, especially 1:1 to 5:1 mol/mol.

Even more preferred is a molar ratio of boron to the metal ion of the metallocene from 1:1 to less than 2:1 mol/mol, e.g from 1:1 to 1.8:1 or 1:1 to 1.5:1.

According to the present invention preferably a boron containing cocatalyst, as described above, is used.

Preferably, the first catalyst is the same as the second catalyst or the first catalyst is different from the second catalyst, more preferably the first catalyst is the same as the second catalyst.

The reaction temperature in the first polymerization reactor and the second polymerization reactor is preferably such that the first and second polymer, respectively, formed in the polymerisation reaction is completely dissolved in the reaction mixture comprising the solvent, the comonomer(s), the chain transfer agent and the polymer. The reaction temperature is suitably greater than the melting temperature of the polymer.

Preferably, polymerising step a2) is conducted at a first reaction temperature and polymerising step b2) is conducted at a second reaction temperature, wherein the first reaction temperature is the same as or different from the second reaction temperature.

Thus, when the polymer is a homo- or copolymer of ethylene the first reaction temperature in step a2) and the second reaction temperature in step b2) is preferably from 120° C. to 240° C., such as from 140° C. to 220° C., most preferably from 150° C. to 200° C., depending on the content of comonomer units in the polymer. When the polymer is a homo- or copolymer of propylene the first reaction temperature in step a2) and the second reaction temperature in step b2) is preferably from 120° C. to 250 ° C., such as from 140° C. to 235° C., most preferably from 150° C. to 225° C., depending on the content of comonomer units in the polymer.

The reactor pressure in the first and second polymerisation reactor depends on the temperature on the one hand, and the type and the amount of the comonomer on the other hand.

Preferably, polymerising step a2) is conducted at a first reactor pressure and polymerising step b2) is conducted at a second reactor pressure, wherein the first reactor pressure is the same as or different from the second reactor pressure.

The first reactor pressure and the second reactor pressure is preferably from 50 to 300 bar, more preferably from 60 to 250 bar and most preferably from 70 to 200 bar.

Preferably, the first polymer has a first density and the second polymer has a second density, wherein the first density is different from the second density.

A solvent is preferably introduced into the first polymerisation reactor and the second polymerisation reactor. The solvent may be any suitable straight-chain or branched alkyl having from 3 to 20 carbon atoms, a cyclic alkyl, optionally having alkyl substituents, having from 5 to 20 carbon atoms, or an aryl, optionally having alkyl substituents, having from 6 to 20 carbon atoms, or a mixture of two or more of the above-listed compounds. The solvent must be inert towards the catalyst and the monomers and comonomers. Further, it should be stable in the polymerisation conditions. It further must be able to dissolve the monomer, the optional comonomers, the optional chain transfer agent and the polymer in the polymerisation conditions.

Preferably, the first feed stream further comprises a solvent and/or a chain transfer agent, and/or the second feed stream further comprises a solvent and/or a chain transfer agent. Alternatively, the solvent and/or the chain transfer agent may be introduced with a stream different from the first feed stream into the first polymerisation reactor and/or the solvent and/or the chain transfer agent may be introduced with a stream different from the second feed stream into the second polymerisation reactor.

The solvent and/or the chain transfer agent introduced into the first polymerisation reactor may be different from the solvent and/or the chain transfer agent introduced into the second polymerisation reactor. However, preferably the solvent and/or the chain transfer agent introduced into the first polymerisation reactor are the same as the solvent and/or the chain transfer agent introduced into the first polymerisation reactor.

A chain transfer agent may be used in one or both of the polymerisation reactors for controlling the molecular weight of the polymer as it is known in the art. A suitable chain transfer agent is, for instance, hydrogen. A chain transfer agent is a substance able to react with growing polymer chain by which the activity of the growing polymer chain is transferred. By maintaining different concentrations of the chain transfer agent in the two reactors it is possible to produce a polymer blend having a broadened molecular weight distribution.

The method according to the invention is preferably operated continuously.

In step a3) a first reactor effluent stream comprising the first polymer is withdrawn from the first polymerisation reactor. The first reactor effluent stream may further comprise unreacted first monomer, optional unreacted comonomer, optional chain transfer agent as well as optional solvent.

The first reactor effluent stream preferably contains from 10 to 35 wt. % first polymer, more preferably from 12 to 30 wt. % first polymer and most preferably from 15 to 25% wt. % first polymer, based on the total weight content of the first reactor effluent stream.

In step b3) a second reactor effluent stream comprising the second polymer is withdrawn from the second polymerisation reactor. The second reactor effluent stream may further comprise unreacted second monomer, optional unreacted comonomer, optional chain transfer agent as well as optional solvent.

The second reactor effluent stream preferably contain from 10 to 35 wt. % second polymer, more preferably from 12 to 30 wt. % second polymer and most preferably from 15 to 25% wt. % second polymer, based on the total weight content of the second reactor effluent stream.

Heating

Preferably, the method further comprises a heating step a4) between step a3) and step c1), wherein in heating step a4) the first reactor effluent stream withdrawn from the first polymerisation reactor in step a3) is heated to provide a heated first reactor effluent stream before blending step c1) and/or further comprises a heating step b4) between step b3) and step c1), wherein the second reactor effluent stream withdrawn from the second polymerisation reactor in step b3) is heated to provide a heated second reactor effluent stream before blending step c1). More preferably, the method further comprises a heating step a4) between step a3) and step c1), wherein in heating step a4) the first reactor effluent stream withdrawn from the first polymerisation reactor in step a3) is heated to provide a heated first reactor effluent stream before blending step c1) and further comprises a heating step b4) between step b3) and step c1), wherein the second reactor effluent stream withdrawn from the second polymerisation reactor in step b3) is heated to provide a heated second reactor effluent stream before blending step c1).

The purpose of the heating steps a4) and b4) is to heat the first reactor effluents stream and the second reactor effluent stream, respectively, before they enter the blending step c1) or a separation step before step c1).

Heating is preferably performed in the first heater and/or second heater as described above, such as a heat exchanger.

Typically the temperature of the first reactor effluent stream before entering the first heater is from 110° C. to 250° C., preferably from 120° C. to 240° C., most preferably from 130° C. to 230° C., if the first polymer is a homo- or copolymer of ethylene.

Typically the temperature of the second reactor effluent stream before entering the second heater is from 120° C. to 240° C., preferably from 140° C. to 220° C., most preferably from 150° C. to 200° C., if the second polymer is a homo- or copolymer of ethylene. Typically the temperature of the second reactor effluent stream before entering the first heater is from 120° C. to 250° C., preferably from 140° C. to 235° C., most preferably from 150° C. to 225° C., if the second polymer is a homo- or copolymer of propylene.

Preferably, the temperature of the heated first reactor effluent stream downstream of the first heater is typically from 200° C. to 300° C., preferably from 210° C. to 260° C. and more preferably from 210° C. to 230° C., if the first polymer is a homo- or copolymer of ethylene or typically from 200° C. to 300° C., preferably from 210° C. to 270° C. and more preferably from 220° C. to 250° C., if the first polymer is a homo- or copolymer of propylene.

Preferably, the temperature of the heated second reactor effluent stream downstream of the second heater is typically from 200° C. to 300° C., preferably from 210° C. to 260° C. and more preferably from 210° C. to 230° C., if the second polymer is a homo- or copolymer of ethylene or typically from 200° C. to 300° C., preferably from 210° C. to 270° C. and more preferably from 220° C. to 250° C., if the second polymer is a homo- or copolymer of propylene.

It is preferred that the pressure of the heated first reactor effluent stream and the heated second reactor effluent stream is not substantially affected by the heating steps a4) and b4), respectively. The pressure of the heated first reactor effluent stream and the heated second reactor effluent stream is suitably from 50 to 300 bar, preferably from 50 to 250 bar and more preferably from 70 to 200 bar.

Separation

Preferably, the method further comprises a separation step a5) between step a3) and step c1) or, if a first heater is present, between step a4) and step c1). In separation step a5), the first reactor effluent stream withdrawn from the first polymerisation reactor in step a3) or the heated first reactor effluent stream withdrawn from the first heater in step a4) is separated in a first separator to provide a first polymer-lean vapour stream and a first polymer-enriched liquid stream.

Preferably, the method further comprises a separation step b5) between step b3) and step c1) or, if a second heater is present, between step b4) and step c1). In separation step b5), the second reactor effluent stream withdrawn from the second polymerisation reactor in step a3) or the heated second reactor effluent stream withdrawn from the second heater in step b4) is separated in a second separator to provide a second polymer-lean vapour stream and a second polymer-enriched liquid stream.

Preferably, the method comprises both the separation step a5) and the separation step b5) as described above.

Preferably, the first separator and/or the second separator are low pressure separators. In the low pressure separators the temperature and pressure will be adjusted such that a liquid phase and a vapour phase are obtained. The polymer is dissolved in the liquid phase which comprises a part of the optional solvent and a part of the optional unreacted comonomer while most part of the unreacted monomer, optional unreacted chain transfer agent, optional a part of the unreacted comonomer, and eventually, a part of the solvent form the vapour phase.

The temperature in the separation step a5) is preferably within the range of from 120° C. to 240° C., more preferably from 140° C. to 220° C. and more preferably from 150° C. to 200° C., if the polymer is a homo- or copolymer of ethylene. The temperature in the separation step a5) is preferably within the range of from 120° C. to 240° C., preferably from 140° C. to 220° C. and more preferably from 150° C. to 200° C., if the polymer is a homo- or copolymer of propylene.

The pressure in the separation step a5) is preferably from 1 to 15 bar, more preferably from 2 to 12 bar and more preferably from 5 to 10 bar.

The temperature in the separation step b5) is preferably within the range of from 120° C. to 240° C., more preferably from 140° C. to 220° C. and more preferably from 150° C. to 200° C., if the polymer is a homo- or copolymer of ethylene. The temperature in the separation step b5) is preferably within the range of from 120° C. to 240° C., preferably from 140° C. to 220° C. and more preferably from 150° C. to 200° C., if the polymer is a homo- or copolymer of propylene.

The pressure in the separation step b5) is preferably from 1 to 15 bar, more preferably from 2 to 12 bar and more preferably from 5 to 10 bar.

The conditions in both separation steps a5) and b5) should be as such that no unwanted polymerization downstream the reactors can occur which would necessitate killing of the catalysts usually with polar substances. Thus, in a preferred aspect of the present invention no catalyst killing is added to the first reactor effluent stream, or the heated first reactor effluent stream, and the second reactor effluent stream, or the heated second reactor effluent stream, before or during the separation steps a5) and b5), respectively.

In another aspect of the present invention, which, however, is not preferred, catalyst killing agent is added to the first reactor effluent stream, or the heated first reactor effluent stream, and the second reactor effluent stream, or the heated second reactor effluent stream, before or during the separation steps a5) and b5), respectively. The catalyst killing agent is usually a polar component such as water, alcohols (such as methanol and ethanol), sodium/calcium stearate, CO, and combinations thereof.

As discussed above, the conditions in the separation step need to be such that the vapour phase and the liquid phase are formed. Hence, a polymer-enriched phase and a polymer-lean phase are obtained as discussed above. The temperature and pressure are set such that vapour-liquid separation takes place and a two-phase system comprising a polymer-enriched liquid phase and a polymer-lean vapour phase results. These two phases are then separated from each other.

The polymer-lean vapour phase is then separated from the polymer-enriched liquid phase in each of the low-pressure separators to form separated polymer-lean vapour streams and polymer-enriched liquid streams.

The separation step may be conducted according to any separation method known in the art where a liquid phase and a vapour phase coexist. It is preferred to conduct the separation step as a flashing step, because of the easiness of operation. As it is well known in the art the liquid feed is passed to a vessel operated at a reduced pressure. Thereby a part of the liquid phase vaporises and can be withdrawn as an overhead stream (or a vapour stream) from the flash. The part remaining in liquid phase is then withdrawn as a bottom stream (or a liquid stream).

The advantage of having a vapour phase and a liquid phase present in the separation step is for the first a simple apparatus and thus low investment cost. In addition, the carry-over of polymer with the vapor stream is relatively small. A polymer-enriched liquid stream is withdrawn from the liquid phase of the separation step.

In a preferred embodiment the separation step is a flashing step as discussed below. The flashing step is suitably conducted in a flash vessel as separator which is a vertical vessel preferably having a generally cylindrical shape. Thereby the flash vessel has a section which has approximately a circular cross-section. Preferably the flash vessel has a cylindrical section which has a shape of a circular cylinder. In addition to the cylindrical section the flash vessel may have additional sections, such as a bottom section, which may be conical, and a top section which may be hemispherical. Alternatively, the flash vessel may also have a generally conical shape.

The temperature in the flash vessel is typically from 120 to 240° C. The temperature should be sufficiently high to keep the viscosity of the liquid stream at a suitable level but less than the temperature where the polymer is degraded. The pressure in the flash vessel is typically from 15 bar to atmospheric, or even less than atmospheric.

The first reactor effluent stream or the heated first reactor effluent stream enters the flash vessel at the top. The liquid stream travels downwards in the flash vessel while the gases which evaporate from the liquid stream travel upwards. According to this preferred embodiment the liquid stream forms a thin film which falls downwards in the flash vessel. This facilitates the removal of hydrocarbons from the liquid stream. The first polymer-lean vapour stream formed from the evaporated gases is typically withdrawn from the top of the flash vessel while the first polymer-enriched liquid stream is withdrawn from the bottom. The above equally pertains to the second reactor effluent stream or the heated second reactor effluent stream.

According to an especially preferred embodiment the first reactor effluent stream or the heated first reactor effluent stream is sprayed in the flash vessel. The spraying can be done by using one or more suitable nozzles which disperse the unreduced reactor effluents stream into droplets. Such nozzles are well known in the industry and include air atomising nozzles, flat fan nozzles, hollow cone nozzles and full cone nozzles. Preferably the nozzles break the stream into droplets having the size of not more than about 1 mm. The above equally pertains to the second reactor effluent stream or the heated second reactor effluent stream.

The nozzle forms a stream of droplets in the flash vessel. The stream of droplets then coagulates within the flash vessel and forms a falling film having a relatively high surface area. This enhances the mass transfer of the volatile components from the solution.

As described above the flash vessel can have a vertical generally cylindrical shape. Then the stream of droplets is directed tangentially with the wall of the flash vessel by a suitable position of the nozzle. Thus, the nozzle is suitably located relatively near to the wall so that its outlet is directed tangentially with the wall. When the stream of the droplets exits the nozzle it moves in the direction of the wall forming a downwards falling film. It is also possible that the flash vessel has a vertical generally conical shape. In such embodiment it is possible to direct the stream of the droplets tangentially with the wall of the flash vessel, as described above. However, it is also possible direct the droplets axially towards the wall of the flash vessel. The nozzle or the nozzles are then arranged eccentrically within the flash vessel. In both arrangements the liquid stream forms a falling film within the flash vessel.

The polymer content in the first polymer-enriched liquid stream withdrawn from the first separator is typically from 40 to 90% by weight, preferably from 50 to 80% by weight and most preferably from 60 to 75% by weight, based on the total weight content of the first polymer-enriched liquid stream. In other words, the first polymer-enriched liquid stream withdrawn from the flashing stage typically contains from 10 to 60% by weight, preferably from 20 to 50% by weight and most preferably from 25 to 40% by weight of residual hydrocarbons, based on the total weight content of the first polymer-enriched liquid stream.

When viewed from a different angle, the first polymer-lean vapour stream withdrawn from the first separator is from 35 to 80% by weight from the total material streams withdrawn from the flash vessel. The polymer-lean vapour stream typically comprises unreacted monomer and also solvent and unreacted comonomer.

By using the flash as described above it is possible to achieve high separation efficiency. For instance, separation efficiency for hydrocarbons containing 6 carbon atoms is at least 75% and preferably at least 80%. Additionally still, separation efficiency for hydrocarbons containing 8 carbon atoms is at least 60% and preferably at least 65%. The separation efficiency is defined as the mass flow of the component withdrawn in the vapour stream divided by the (theoretical) mass flow rate of the component in the vapour stream in equilibrium conditions.

In blending step c1) the first polymer comprised in the first polymer-enriched liquid stream and the second polymer comprised in the second polymer-enriched liquid stream are blended in a blending unit so as to obtain the in-line blended polymer.

In a preferred aspect both the first and second polymer-enriched liquid streams are heated before, during or after said blending in the blending unit.

The blending unit in step c1) is preferably a mixer or a separator.

When a mixer is used for blending the polymer-enriched liquid streams the mixer is preferably a static mixer. Static mixers are well known in the art and the person skilled in the art is capable of selecting a suitable mixer for the process. The use of the mixer enhances the mixing of the polymer-enriched liquid streams, on one hand, and the mass transfer of the volatile components from the liquid phase to the vapour phase, on the other hand by substantially increasing the mass transfer area.

In case the blending unit is a separator, the separator is preferably a flash separator or low-pressure separator. A low-pressure separator is usually only used when the separation efficiency in the low-pressure separators in steps a5) and b5) is not sufficient, i.e. the content of residual hydrocarbons in polymer-enriched liquid streams withdrawn from the low-pressure separators is rather high.

When a low pressure separator is used for blending both polymer-enriched liquid streams in step c1), i.e. practically streams consisting essentially of polymer only, the thereby obtained blended polymer-lean vapour phase may be recycled back as blended polymer-lean vapour stream to any or all of the polymerization reactors.

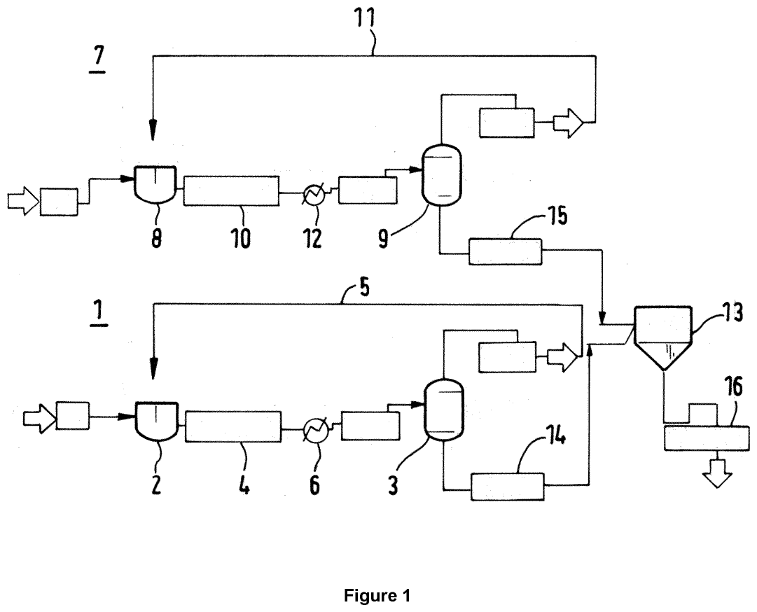

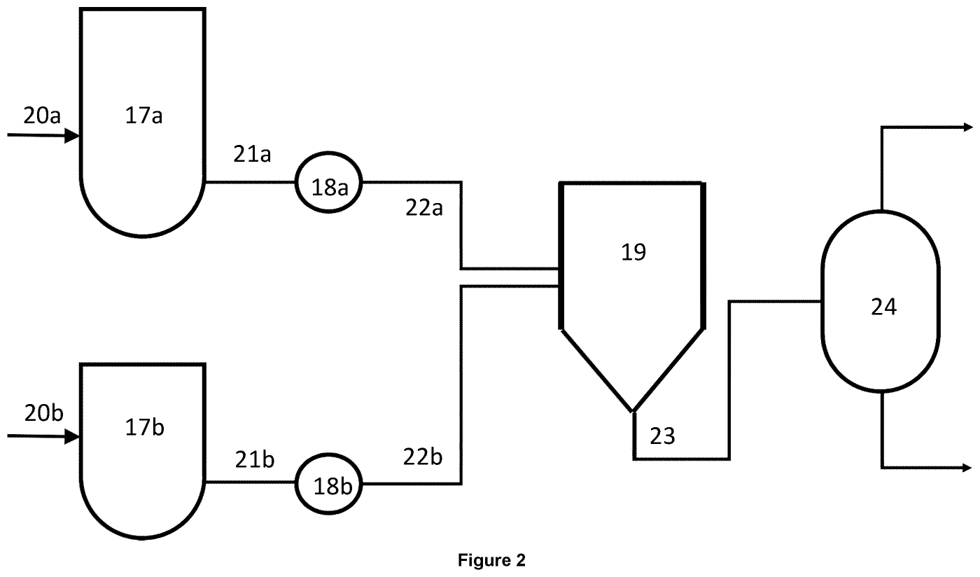

To further illustrate the invention two exemplary embodiments of the invention are described using FIGS. 1 and 2.

FIG. 1 shows an exemplary embodiment the configuration of the plant according to the first aspect of the invention. The plant comprises a first reactor line and a second reactor line.

The first reactor line (1) for producing a first polymer includes a first polymerisation reactor (2) and a first separator (3). The first polymerisation reactor (2) comprises a first reactor inlet for introducing a first feed stream into the first reactor (2) and a first reactor outlet for withdrawing a first reactor effluent stream comprising the first polymer. The first reactor outlet is fluidly connected via a first connecting line (4) to an inlet of the first separator (3). The first separator (3) comprises a bottom outlet for withdrawing a first polymer-enriched liquid stream, the bottom outlet being connected via a second connecting line (14) to the blending unit (13). The first separator (3) further comprises a top outlet for withdrawing a first polymer-lean vapour stream. A first recycling line (5) connects the top outlet of the separator (3a) back to the first polymerisation reactor (2) to recycle the first polymer-lean vapour stream back into the first polymerisation reactor (2).

In analogy to the first reactor line (1), the second reactor line (7) according to the first aspect of the invention produces a second polymer and includes a second polymerisation reactor (8) and a second separator (9). The second polymerisation reactor (8) comprises a second reactor inlet for introducing a second feed stream into the reactor (8) and a second reactor outlet for withdrawing a second reactor effluent stream comprising the second polymer. The second reactor outlet is fluidly connected via a third connecting line (10) to an inlet of the second separator (9). The second separator (9) comprises a bottom outlet for withdrawing a second polymer-enriched liquid stream, the bottom outlet being connected via a fourth connecting line (15) to the blending unit (13). The second separator (9) further comprises a top outlet for withdrawing a second polymer-lean vapour stream. A recycling line (11) connects the top outlet of the separator (9) back to the second polymerisation reactor (8) to recycle the second polymer-lean vapour stream back into the second polymerisation reactor (8).

The internal volume of the first polymerisation reactor (2) is 1.5 times larger than the internal volume of the first polymerisation reactor (8).

A first heater (6) and a second heater (12) are located downstream of the first polymerisation reactor (2) and upstream of the blending unit (13) and downstream of second polymerisation reactor (9) and upstream of the blending unit (13), respectively, see FIG. 1.

The first heater (2a) heats the first reactor effluent stream to provide a heated first reactor effluent stream, the heated first reactor effluent stream being introduced into the first separator (3). The second heater (12) heats the second reactor effluent stream to provide a heated second reactor effluent stream, the heated second reactor effluent stream being introduced into the second separator (9).

The blending unit (13) is connected via the second connecting line (14) to the first separator (3) and via the fourth connecting line (15) to the second separator (9). Line (14) passes the first polymer-enriched liquid stream from the first separator (3) into the blending unit (13), whereas line (15) passes the second polymer-enriched liquid stream from the second separator (9) into the blending unit (13). In the blending unit (13), which is in this exemplary embodiment a static mixer, the first polymer from the first polymer-enriched liquid stream and the second polymer from the second polymer-enriched liquid stream are in-line blended so as to obtain an in-line blended polymer.

Blending unit (13) further comprises a bottom outlet connected to a withdrawing line (16) for withdrawing an in-line blended polymer stream comprising the in-line blended polymer.

FIG. 2 shows an exemplary embodiment of the configuration of the plant according to the second aspect of the invention.

The plant of the second aspect comprises a first polymerisation reactor (17a) and a second polymerisation reactor (17b). The first polymerisation reactor (17a) comprises a first reactor inlet (20a) for introducing a first feed stream into the reactor (17a) and a first reactor outlet for withdrawing a first reactor effluent stream comprising the first polymer. The first reactor outlet is fluidly connected via connecting line (21a) and line (22a) to an inlet of a blending unit (19). The blending unit (19) is in this exemplary embodiment a mixer.

The second polymerisation reactor (17b) comprises a second reactor inlet (20b) for introducing a second feed stream into the reactor (17b) and a second reactor outlet for withdrawing a second reactor effluent stream comprising the first polymer. The second reactor outlet is fluidly connected via connecting line (21b) and line (22b) to an inlet of the blending unit (19).

The internal volume of the first polymerisation reactor (17a) is 1.5 times larger than the internal volume of the second polymerisation reactor (17b) which is schematically seen in FIG. 2.

A first heater (18a) and a second heater (18b) are located downstream of the first polymerisation reactor (17a) and upstream of the blending unit (19) and downstream of second polymerisation reactor (17b) and upstream of the blending unit (19), respectively, see FIG. 2.

In the blending unit (19) the first polymer from the first reactor effluent stream and the second polymer from the second reactor effluent stream are in-line blended so as to obtain an in-line blended polymer.

Blending unit (19) further comprises a bottom outlet connected to a withdrawing line (23) for withdrawing an in-line blended polymer stream comprising the in-line blended polymer. A flash separator (24) is optionally located downstream of the blending unit (19).

### EXAMPLE SECTION

### 1. Measurement Methods

a) Melt Flow Rate (MFR) and Flow Rate Ratio (FRR)

The melt flow rate (MFR) is determined according to IS01133—Determination of the melt mass-flow rate (MFR) and melt volume-flow rate (MVR) of thermoplastics—Part 1: Standard method, and is indicated in g/10 min. The MFR is an indication of flowability, and hence processability, of the polymer. The higher the melt flow rate, the lower the viscosity of the polymer.

The MFR₂ of polypropylene is determined at a temperature of 230° C. and a load of 2.16 kg.

The MFR₂ of polyethylene is determined at a temperature of 190° C. and a load of 2.16 kg.

The flow rate ratio (FRR) is the MFR₂₁/MFR₂.

b) Density

The density of the polymer was measured according to IS01183.

c) Comonomer Content

Quantitative nuclear-magnetic resonance (NMR) spectroscopy was used to quantify the comonomer content of the polymers.

Quantitative ¹³C{¹H} NMR spectra recorded in the molten-state using a Bruker Avance III 500 NMR spectrometer operating at 500.13 and 125.76 MHz for ¹H and ¹³C respectively. All spectra were recorded using a ¹³C optimised 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification. Standard single-pulse excitation was employed utilising the transient NOE at short recycle delays of 3 s and the RS-HEPT decoupling scheme. A total of 1024 (1 k) transients were acquired per spectrum.

Quantitative ¹³C{¹H} NMR spectra were processed, integrated and quantitative properties determined using custom spectral analysis automation programs. All chemical shifts are internally referenced to the bulk methylene signal (d+) at 30.00 ppm.

Characteristic signals corresponding to the incorporation of 1-octene were observed and all comonomer contents calculated with respect to all other monomers present in the polymer.

Characteristic signals resulting from isolated 1-octene incorporation i.e. EEOEE comonomer sequences, were observed. Isolated 1-octene incorporation was quantified using the integral of the signal at 38.3 ppm. This integral is assigned to the unresolved signals corresponding to both *B6 and *bB6B6 sites of isolated (EEOEE) and isolated double non-consecutive (EEOEOEE) 1-octene sequences respectively. To compensate for the influence of the two *bB6B6 sites the integral of the bbB6B6 site at 24.6 ppm is used:

O=I_{*-B6+*bB6B6}−2*I_{bbB6B6}

Characteristic signals resulting from consecutive 1-octene incorporation, i.e. EEOOEE comonomer sequences, were also observed. Such consecutive 1-octene incorporation was quantified using the integral of the signal at 40.4 ppm assigned to the aaB6B6 sites accounting for the number of reporting sites per comonomer:

OO=2*I_{aaB6B6}

Characteristic signals resulting from isolated non-consecutive 1-octene incorporation, i.e. EEOEOEE comonomer sequences, were also observed. Such isolated non-consecutive 1-octene incorporation was quantified using the integral of the signal at 24.6 ppm assigned to the bbB6B6 sites accounting for the number of reporting sites per comonomer:

OEO=2*I_{bbB6B6}

Characteristic signals resulting from isolated triple-consecutive 1-octene incorporation, i.e. EEOOOEE comonomer sequences, were also observed. Such isolated triple-consecutive 1-octene incorporation was quantified using the integral of the signal at 41.2 ppm assigned to the aagB6B6B6 sites accounting for the number of reporting sites per comonomer:

OOO=3/2*I_{aagB6B6B6}

With no other signals indicative of other comonomer sequences observed the total 1-octene comonomer content was calculated based solely on the amount of isolated (EEOEE), isolated double-consecutive (EEOOEE), isolated non-consecutive (EEOEOEE) and isolated triple-consecutive (EEOOOEE) 1-octene comonomer sequences:

Oₜₒₜₐₗ=O+OO+OEO+OOO

Characteristic signals resulting from saturated end-groups were observed. Such saturated end-groups were quantified using the average integral of the two resolved signals at 22.9 and 32.23 ppm. The 22.84 ppm integral is assigned to the unresolved signals corresponding to both 2B6 and 2S sites of 1-octene and the saturated chain end respectively. The 32.2 ppm integral is assigned to the unresolved signals corresponding to both 3B6 and 3S sites of 1-octene and the saturated chain end respectively. To compensate for the influence of the 2B6 and 3B6 1-octene sites the total 1-octene content is used:

S=(½)*(I_{2S+2B6}+I_{3S+3B6}−2*Oₜₒₜₐₗ)

The ethylene comonomer content was quantified using the integral of the bulk methylene (bulk) signals at 30.00 ppm. This integral included the D and 4B6 sites from 1-octene as well as the D^{D} sites. The total ethylene comonomer content was calculated based on the bulk integral and compensating for the observed 1-octene sequences and end-groups:

Eₜₒₜₐₗ=(½)*[I_{bulk}+2*O+1*OO+3*OEO+00*OOO+3*S]

It should be noted that compensation of the bulk integral for the presence of isolated triple-incorporation (EEOOOEE) 1-octene sequences is not required as the number of under and over accounted ethylene units is equal.

The total mole fraction of 1-octene in the polymer was then calculated as:

fO=Oₜₒₜₐₗ/(Eₜₒₜₐₗ+Oₜₒₜₐₗ)

The total comonomer incorporation of 1-octene in weight percent was calculated from the mole fraction in the standard manner:

O [wt %]=100*(fO*112.21)/((fO*112.21)+((1−fO)*28.05))

Further information can be found in the following references:
Klimke, K., Parkinson, M., Piel, C., Kaminsky, W., Spiess, H. W., Wilhelm, M., Macromol. Chem. Phys. 2006; 207:382.
Parkinson, M., Klimke, K., Spiess, H. W., Wilhelm, M., Macromol. Chem. Phys. 2007; 208:2128.
NMR Spectroscopy of Polymers: Innovative Strategies for Complex Macromolecules, Chapter 24, 401 (2011)
Pollard, M., Klimke, K., Graf, R., Spiess, H. W., Wilhelm, M., Sperber, O., Piel, C., Kaminsky, W., Macromolecules 2004; 37:813.
Filip, X., Tripon, C., Filip, C., J. Mag. Resn. 2005, 176, 239
Griffin, J. M., Tripon, C., Samoson, A., Filip, C., and Brown, S. P., Mag. Res. in Chem. 2007 45, 51, S198
Castignolles, P., Graf, R., Parkinson, M., Wilhelm, M., Gaborieau, M., Polymer 50 (2009) 2373
Zhou, Z., Kuemmerle, R., Qiu, X., Redwine, D., Cong, R., Taha, A., Baugh, D. Winniford, B., J. Mag. Reson. 187 (2007) 225
Busico, V., Carbonniere, P., Cipullo, R., Pellecchia, R., Severn, J., Talarico, G., Macromol. Rapid Commun. 2007, 28, 1128
J. Randall, Macromol. Sci., Rev. Macromol. Chem. Phys. 1989, C29, 201.
Qiu, X., Redwine, D., Gobbi, G., Nuamthanom, A., Rinaldi, P Macromolecules 2007, 40, 6879
Liu, W., Rinaldi, P., McIntosh, L., Quirk, P., Macromolecules 2001, 34, 4757

d) Unsaturation

Quantitative nuclear-magnetic resonance (NMR) spectroscopy was used to quantify the content of unsaturated groups present in the polymers.

Quantitative ¹H NMR spectra recorded in the solution-state using a Bruker Avance III 400 NMR spectrometer operating at 400.15 MHz. All spectra were recorded using a ¹³C optimised 10 mm selective excitation probehead at 125° C. using nitrogen gas for all pneumatics. Approximately 200 mg of material was dissolved in 1,2-tetrachloroethane-d₂ (TCE-d₂) using approximately 3 mg of Hostanox 03 (CAS 32509-66-3) as stabiliser. Standard single-pulse excitation was employed utilising a 30 degree pulse, a relaxation delay of 10 s and 10 Hz sample rotation. A total of 128 transients were acquired per spectra using 4 dummy scans. This setup was chosen primarily for the high resolution needed for unsaturation quantification and stability of the vinylidene groups. All chemical shifts were indirectly referenced to TMS at 0.00 ppm using the signal resulting from the residual protonated solvent at 5.95 ppm.

Characteristic signals corresponding to the presence of terminal aliphatic vinyl groups (R—CH═CH₂) were observed and the amount quantified using the integral of the two coupled inequivalent terminal CH₂ protons (Va and Vb) at 4.95, 4.98 and 5.00 and 5.05 ppm accounting for the number of reporting sites per functional group:

Nvinyl=IVab/2

When characteristic signals corresponding to the presence of internal vinylidene groups (RR′C═CH₂) were observed the amount is quantified using the integral of the two CH₂ protons (D) at 4.74 ppm accounting for the number of reporting sites per functional group:

Nvinylidene=ID/2

When characteristic signals corresponding to the presence of internal cis-vinylene groups (E-RCH═CHR′), or related structure, were observed the amount is quantified using the integral of the two CH protons (C) at 5.39 ppm accounting for the number of reporting sites per functional group:

Ncis=IC/2

When characteristic signals corresponding to the presence of internal trans-vinylene groups (Z—RCH═CHR′) were observed the amount is quantified using the integral of the two CH protons (T) at 5.45 ppm accounting for the number of reporting sites per functional group:

Ntrans=IT/2

When characteristic signals corresponding to the presence of internal trisubstituted-vinylene groups (RCH═CHR′R″), or related structure, were observed the amount is quantified using the integral of the CH proton (Tris) at 5.14 ppm accounting for the number of reporting sites per functional group:

Ntris=ITris

The Hostanox 03 stabliser was quantified using the integral of multiplet from the aromatic protons (A) at 6.92, 6.91, 6.69 and at 6.89 ppm and accounting for the number of reporting sites per molecule:

H=IA/4

As is typical for unsaturation quantification in polyolefins the amount of unsaturation was determined with respect to total carbon atoms, even though quantified by ¹H NMR spectroscopy. This allows direct comparison to other microstructure quantities derived directly from ¹³C NMR spectroscopy.

The total amount of carbon atoms was calculated from integral of the bulk aliphatic signal between 2.85 and −1.00 ppm with compensation for the methyl signals from the stabiliser and carbon atoms relating to unsaturated functionality not included by this region:

NCtotal=(Ibulk−42*H)/2+2*Nvinyl+2*Nvinylidene+2*Ncis+2*Ntrans+2*Ntris

The content of unsaturated groups (U) was calculated as the number of unsaturated groups in the polymer per thousand total carbons (kCHn):

U=1000*N/NCtotal

The total amount of unsaturated group was calculated as the sum of the individual observed unsaturated groups and thus also reported with respect per thousand total carbons:

Utotal=Uvinyl+Uvinylidene+Ucis+Utrans+Utris

The relative content of a specific unsaturated group (U) is reported as the fraction or percentage of a given unsaturated group with respect to the total amount of unsaturated groups:

[U]=Ux/Utotal

Further information can be found in the following references:
He, Y., Qiu, X, and Zhou, Z., Mag. Res. Chem. 2010, 48, 537-542.
Busico, V. et. al. Macromolecules, 2005, 38 (16), 6988-6996

e) Determination of the Molecular Weight Averages, Molecular Weight Distribution

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i - 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{z} = \frac{{\sum }_{i = 1}^{N} ( {A}_{i} \times {M}_{i}^{2} )}{{\sum }_{i = 1}^{N} ( {A}_{i} / {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with a multiple band infrared detector model IR5 (PolymerChar, Valencia, Spain), equipped with 3× Agilent-PLgel Olexis and 1× Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. at a constant flow rate of 1 mL/min. 200 μL of sample solution was injected per analysis. Data collection was performed by using PolymerChar GPC-one software.

The column set was calibrated using universal calibration (according to ISO 16014-2:2003) with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

K_{PS}=19×10⁻³ mL/g, α_{PS}=0.655

K_{PE}=39×10⁻³ mL/g, α_{PE}=0.725

A third order polynomial fit was used to fit the calibration data.

All samples were prepared in the concentration range of 0.5 to 1 mg/ml and dissolved at 160° C. for 3 hours under continuous gentle shaking.

f) Melting Temperature (Tₘ) and Crystallization Temperature (T_{c})

Experiments were performed with a TA Instruments Q200, calibrated with Indium, Zinc, Tin and according to ISO 11357-3. Roughly 5 mg of material were placed in a pan and tested at 10° C./min throughout the experiments, under 50 mL/min nitrogen flow, with lower and higher temperatures of −30° C. and 180° C. respectively. Only the second heating run was considered for the analysis. The melting temperature Tₘ is defined as the temperature of the main peak of the thermogram, while the melting enthalpy (ΔHm) is calculated by integrating between 10° C. and the end of the thermogram, typically Tₘ+15° C. The running integral in this range is also calculated.

g) Glass Transition Temperature (T_{g})

The glass transition temperature Tg is determined by dynamic mechanical analysis according to ISO 6721-7. The measurements are done in torsion mode on compression moulded samples (40×10×1 mm3) between −100° C. and +150° C. with a heating rate of 2° C./min and a frequency of 1 Hz.

h) Vicat Softening Temperature (T_{vicat})

The Vicat temperature is measured according to ISO 306, method A50. A flat-ended needle loaded with a mass of 10 N is placed in direct contact with an injection moulded test specimen with the dimensions of 80×10×4 mm3 as described in EN ISO 1873-2. The specimen and the needle are heated at 50° C./h. The temperature at which the needle has penetrated to a depth of 1 mm is recorded as the Vicat softening temperature.

2. Materials
a) Comparative Example 1 (CE1)
CE1 is an ethylene based octene-1 plastomer (octene content 15.7 wt. %) having an MFR2 of 1.1 g/10 min, a density of 902 kg/m³ and a melting temperature Tₘ of 97° C., commercially available from Borealis. CE1 was produced in a solution polymerisation process using a metallocene catalyst.
b) Copolymer A is an ethylene based octene-1 plastomer (amount octene 11.9 wt. %), produced in a solution polymerisation process using a metallocene catalyst, having an MFR2 of 1.1 g/10 min, a density of 910 kg/m³ and a melting temperature Tₘ of 106° C.
Copolymer B is an ethylene based octene-1 plastomer (amount octene 25.8 wt. %), produced in a solution polymerisation process using a metallocene catalyst, having an MFR2 of 1.1 g/10 min, a density of 883 kg/m³ and a melting temperature Tₘ of 73° C.
d) Copolymer C is an ethylene based octene-1 elastomer (amount octene 37.1 wt. %), produced in a solution polymerisation process using a metallocene catalyst, having an MFR2 of 1.0 g/10 min, a density of 862 kg/m³ and a melting temperature Tₘ of 35 ° C.
e) Copolymer D is an ethylene based octene-1 elastomer (amount octene 31.5 wt %), produced in a solution polymerisation process using a metallocene catalyst, having an MFR2 of 1.0 g/10 min, a density of 870 kg/m³ and a melting temperature Tₘ of 56° C.

Copolymers A to D were produced with Borealis proprietor Borceed™ solution polymerization technology, in the present of metallocene catalyst (phenyl)(cyclohexyl) methylene (cyclopentadienyl) (2,7-di-tert-butylfluorenyl) hafnium dimethyl and N,N-Dimethylanilinium Tetrakis(pentafluorophenyl)borate (AB) (CAS 118612-00-3) was used, commercially available from Boulder, as cocatalyst.

The polymerization conditions, were selected in such a way that the reacting system is one liquid phase. (T between 130 and 230° C.; 60 to 150 bar)

3. Results

Blending of the respective material was done using Prism TSE-16, a 16 mm co-rotating twin screw extruder with L/D 25, with throughput of approximately 1.4 kg/h. Temperature profile was set to 180-200° C. and the machine was operated at 250 rpm. Samples were produced by mixing a dry blend of base resin pellets and extruding said mixture. Around 2.5 kg of dry blend was fed to hopper for the batch and after stabilisation around 2.0 kg of the final extruded blend was collected.

The inventive examples 1E1-1 to 1E1-3 are blends of two copolymers in specific blend ratios. Results are provided in Table 1 below.

TABLE 1
Results

| | CE1 | IE1-1 | IE1-2 | IE1-3 |
|---|---|---|---|---|
| Blend ratio | — | 83 wt. % | 80 wt. % | 71 wt. % |
| | | Copo. A | Copo. A | Copo. A |
| | | 17 wt. % | 20 wt. % | 29 wt. % |
| | | Copo. C | Copo. D | Copo. B |
| C8 content, | 15.7 | 14.9 | 15.2 | 15.3 |
| wt. % | | | | |
| Density, | 902 | 902 | 903.1 | 902.1 |
| kg/m³ | | | | |
| M_{w}, g/mol | 81650 | 81350 | 82800 | 82250 |
| M_{w}/Mₙ | 2.6 | 2.72 | 2.64 | 2.72 |
| MFR₂, g/10 min | 1.1 | 1.02 | 0.99 | 1.03 |
| MFR₂₁, g/10 min | 31.54 | 37.05 | 37.53 | 36.3 |
| MFR₂₁/MFR₂ | 30.62 | 36.32 | 37.91 | 35.24 |
| Tₘ, ° C. | 97 | 102.63 | 103.7 | 102.01 |
| T_{c}, ° C. | 78.42 | | 89.9 | |
| T_{g}, ° C. | −35.48 | | −41.55 | −41.55 |
| T_{Vicat}, ° C. | 82 | | 87.2 | |
| Vinylidene, | 12.3 | 11.5 | 12.1 | 12.1 |
| 100kCHn | | | | |
| Vinyl, | 5.6 | 5.0 | 6.9 | 5.8 |
| 100kCHn | | | | |
| Trisubst, | 19.2 | 17.7 | 17.40 | 21.2 |
| 100kCHn | | | | |
| Vinylene, | 8.8 | 12.7 | 14.40 | 14.0 |
| 100kCHn | | | | |

The above results show that blending two different copolymers targeting an existing product (CE1) leads to copolymers (1E1-1 to 1E1-3) with significantly better melting temperature Tₘ as well as improved T_{g}, improved T_{c} and improved T_{Vicat} at comparable density, melt flow rate, M_{w} and 1-octene comonomer content.

1. Plant for the production of an in-line blended polymer, the plant comprising
a first reactor line for producing a first polymer,
a second reactor line for producing a second polymer, and
a blending unit for inline-blending the first polymer with the second polymer to obtain the inline-blended polymer,
the first reactor line comprising a first polymerisation reactor for producing the first polymer and a first separator, the first separator being located downstream of the first polymerisation reactor,
the second reactor line comprising a second polymerisation reactor for producing the second polymer and a second separator, the second separator being located downstream of the second polymerisation reactor,
wherein both the first separator and the second separator are connected to the blending unit, the blending unit being located downstream of both the first separator and the second separator,
wherein the first polymerisation reactor has a first internal volume and the second polymerisation reactor has a second internal volume,
characterized in that the ratio of the first internal volume to the second internal volume is in the range from 95:5 to 55:45, and
in that the blending unit comprises a flash separator.

2. The plant according to claim 1, wherein a first heater is located downstream of the first polymerisation reactor and upstream of the first separator, or wherein a second heater is located downstream of the second polymerization reactor and upstream of the second separator.

3. The plant according to claim 1, wherein the first separator comprises a top outlet and a bottom outlet, or wherein the second separator comprises a top outlet and a bottom outlet.

4. Plant for the production of an inline-blended polymer, the plant comprising
a first polymerisation reactor for producing a first polymer,
a second polymerisation reactor for producing a second polymer and a blending unit for inline-blending the first polymer with the second
polymer to obtain to obtain the inline-blended copolymer,
wherein both the first polymerisation reactor and the second polymerisation reactor are connected to the blending unit, the blending unit being located downstream of both the first polymerisation reactor and the second polymerisation reactor,
wherein a first heater is located downstream of the first polymerisation reactor and upstream of the blending unit and/or wherein a second heater is located downstream of the second polymerisation reactor and upstream of the blending unit,
wherein the first polymerisation reactor has a first internal volume and the second polymerisation reactor has a second internal volume,
characterized in that the ratio of the first internal volume to the second internal volume is in the range from 95:5 to 55:45, and
in that the blending unit comprises a flash separator.

5. The plant according to claim 1, wherein the first polymerisation reactor comprises a first reactor inlet for introducing a first feed stream into the first polymerisation reactor and a first reactor outlet for withdrawing a first reactor effluent stream comprising the first polymer or wherein the second polymerisation reactor comprises a second reactor inlet for introducing a second feed stream into the second polymerisation reactor and a second reactor outlet for withdrawing a second reactor effluent stream comprising the second polymer.

6. The plant according to claim 1, wherein the ratio of the first internal volume to the second internal volume is from 85:15 to 60:40.

7. The plant according to claim 1, wherein the blending unit has an outlet for withdrawing the inline-blended polymer.

8. Method for producing an in-line blended polymer, the method being performed in a plant according to claim 1, the method comprising the steps of
a1) introducing a first feed stream comprising a first monomer into a first polymerisation reactor,
a2) polymerising the first monomer in the presence of a first catalyst in the first polymerisation reactor to obtain a first polymer,
a3) withdrawing a first reactor effluent stream comprising the first polymer from the first polymerisation reactor,
b1) introducing a second feed stream comprising a second monomer into a second polymerisation reactor,
b2) polymerising the second monomer in the presence of a second catalyst in the second polymerisation reactor to obtain a second polymer,
b3) withdrawing a second reactor effluent stream comprising the second polymer from the second polymerisation reactor,
c1) blending the first polymer and the second polymer in a blending unit to obtain the in-line blended polymer.

9. The method according to claim 8, wherein the first catalyst comprises a metallocene complex and/or the second catalyst comprises a metallocene complex.

10. The method according to claim 8, wherein polymerising step a2) is conducted at a first reaction temperature and polymerising step b2) is conducted at a second reaction temperature, wherein the first reaction temperature is the same as or different from the second reaction temperature.

11. The method according to claim 9, wherein polymerising step a2) is conducted at a first reactor pressure and polymerising step b2) is conducted at a second reactor pressure, wherein the first reactor pressure is the same as or different from the second reactor pressure.

12. The method according to claim 8, wherein the first monomer or the second monomer is ethylene.

13. The method according to claim 8, wherein the first feed stream further comprises a comonomer, or wherein the second feed stream further comprises a comonomer.

14. The method according to claim 8, wherein the first feed stream further comprises a solvent.

15. The method according to claim 13, wherein the comonomer is octene.

16. The method according to claim 8, wherein the first feed stream further comprises a chain transfer agent.

17. The method according to claim 8, wherein the second feed stream further comprises a solvent.

18. The method according to claim 8, wherein the second feed stream further comprises a chain transfer agent.
